(19) United States
(12) Patent Application Publication
(10) Pub. No.: US 2009/0042122 A1
(43) Pub. Date: Feb. 12, 2009

(54) METHODS OF PRODUCING TONER COMPOSITIONS AND TONER COMPOSITIONS PRODUCED THEREFROM

(75) Inventors: JEAN GUAY, EDEN PRAIRIE, MN (US); MARK CUMMINGS, SAVAGE, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: KATUN CORPORATION, MINNEAPOLIS, MN (US)

(21) Appl. No.: 12/188,037

(22) Filed: Aug. 7, 2008

Related U.S. Application Data
(60) Provisional application No. 60/954,752, filed on Aug. 8, 2007.

(51) Int. Cl. G03G 9/09

(52) U.S. Cl. 430/111.4; 430/137.11; 430/105

(57) ABSTRACT

Toner compositions, methods for making toner compositions, and methods for coating toner particles. A method for coating toner particles may include mixing dry toner particles and a dispersion including shell particles to coat at least a portion of an exterior surface of the toner particles with an essentially continuous layer of the shell particles. The toner particles may comprise a first resin and a coloring agent. The shell particles may comprise a second resin.

### CROSS-REFERENCE TO RELATED APPLICATIONS

This application claims the benefit of priority to U.S. Provisional Application No. 60/954,752, filed Aug. 8, 2007, which is herein incorporated by reference.

### FIELD OF THE INVENTION

The invention relates to methods of coating core particles with a shell layer. In particular, the invention relates to core/shell toner compositions for electrophotography and to methods for producing such toner compositions.

### BACKGROUND OF THE INVENTION

Electrophotographic processes can include the steps of forming a latent image on a photosensitive member, developing the latent image using a toner, transferring the toned image to paper or another substrate and fixing the toned image by heat, pressure or a combination thereof.

Toners for use in electrophotographic processes generally include a binder resin and one or more additives (e.g., coloring agents, charge control agents and releasing agents) dispersed in the binder resin. Dry toners can be produced by “traditional” methods that include, e.g., mixing the additives into the binder resin, grinding the mixture to form particles, and classifying the particles.

In recent years, technological developments in printing and copying equipment have increased the demands on toner properties to achieve desired print quality. For example, the current trend in laser printers and copies is toward faster, more energy efficient, color capable machines, which can impose lower fusing temperature requirements on the toner. Achieving desired print quality using toners produced by traditional toner manufacturing methods can be difficult since the relatively low melting properties required for the faster machines can result in release problems such as hot offset. Hot offset can occur when the melted toner film does not completely release from the fuser roller. In other words, a portion of the toner film transfers to the paper or other substrate and a portion of the toner film remains on the fuser roller, which can contaminate the fuser roller and reduce the print quality of subsequent prints.

One method of addressing the hot offset problem is to produce a core/shell toner that includes a lower melting core enveloped by a higher melting shell. Core/shell toners can be chemically prepared toners produced by polymerization methods such as emulsion aggregation, dispersion polymerization and suspension polymerization. Chemically prepared toners are discussed in U.S. Pat. No. 7,217,488 to Mikuriya et al., entitled, “Toner Comprising Core Layer And Shell Layer”, which is incorporated herein by reference. However, the production of chemically prepared toners can involve complex equipment and technical production procedures, which increases the manufacturing costs of the toner. In addition, the polymerization methods employed in forming chemically prepared toners can impose limitations on the selection of the core and shell resins.

### SUMMARY OF THE INVENTION

In some aspects, some example embodiments pertain to a method for coating toner particles that comprises mixing dry toner particles and a dispersion comprising shell particles to coat at least a portion of an exterior surface of the toner particles with an essentially continuous layer of the shell particles, wherein the toner particles comprise a first resin and a coloring agent, and wherein the shell particles comprise a second resin.

In some embodiments, the glass transition temperature of the first resin is equal to or lower than the glass transition temperature of the second resin. In some embodiments, the first resin has a glass transition temperature of from about 40° C. to about 75° C. In some embodiments, the second resin has a glass transition temperature from about 50° C. to about 120° C.

In some embodiments, the first resin may be selected from the group consisting of polyester resins, styrene acrylic copolymers, polystyrene, hydrogenated styrene resins, styrene isobutylene copolymers, ABS resins, ASA resins, AS resins, AAS resins, ACS resins, AES resins, styrene propylene copolymers, styrene butadiene copolymers, (meth)acrylic resins, polyethylene, polypropylene, polyurethane resins, polyamide resins, silicone resins, and blends and copolymers thereof.

In some embodiments, the second resin may be selected from the group consisting of polyester resins, styrene acrylic copolymers, polystyrene, hydrogenated styrene resins, styrene isobutylene copolymers, ABS resins, ASA resins, AS resins, AAS resins, ACS resins, AES resins, styrene propylene copolymers, styrene butadiene copolymers, (meth)acrylic resins, polyethylene, polypropylene, polyurethane resins, polyamide resins, silicone resins, and blends and copolymers thereof.

In some embodiments, the dry toner particles further comprise a releasing agent, charge control agent, or a combination thereof.

In some embodiments, the dry toner particles have an average particle size by volume of from about 2 micrometers to about 20 micrometers. In some embodiments, the dispersion comprises water.

In some embodiments, the shell particles are present in the mixing device at a concentration of from about 0.1% by weight to about 20% by weight based on the weight of the dry toner particles. In other embodiments, the shell particles are present in the mixing device at a concentration of from about 5% by weight to about 10% by weight based on the weight of the dry toner particles.

In some embodiments, the shell particles form an essentially continuous layer over at least 20%, at least 50%, at least 75%, at least 90% or at least 95% of the exterior surface of the toner particles.

In some embodiments, the dry toner particles and the dispersion are mixed in a mixing device that comprises a mixing blade, wherein the mixing blade is rotated at a peripheral speed from about 20 meters/second to about 60 meters/second, or even from about 25 meters/second to about 40 meters/second. In some embodiments, the mixing device comprises a vertical, high intensity mixer.

In some embodiments, the dry toner particles and the dispersion are mixed under conditions sufficient to raise a temperature of the mixture to within a range of about plus or minus 5° C. of the glass transition temperature of the first resin. In other embodiments, the dry toner particles and the dispersion are mixed under conditions sufficient to raise a temperature of the mixture to within a range of about plus or minus 3° C. of the glass transition temperature of the first resin.

In some embodiments, the method can further include drying the coated core toner particles and screening the coated toner particles to obtain particles having a desired size range.

In some aspects, some example embodiments pertain to a method for coating particles that comprises pre-conditioning a mixing device and mixing toner particles and a dispersion comprising shell particles in the pre-conditioned mixing device to coat at least a portion of the exterior surface of the toner particles with an essentially continuous layer of the shell particles, wherein the toner particles comprise a first resin and a coloring agent, and the shell particles comprise a second resin.

In some aspects, some example embodiments pertain to a toner composition that comprises a core toner particle comprising a first resin and a coloring agent, and an essentially continuous coating surrounding the core toner particle, wherein the essentially continuous coating comprises a second resin, and wherein the first resin is different than the second resin.

In some embodiments, the first resin can comprise polyester and the second resin can comprise a styrene acrylic copolymer. In other embodiments, the first resin can comprise a styrene acrylic copolymer and the second resin can comprise polyester.

In some aspects, some example embodiments pertain to a toner composition that comprises core toner particles comprising a first resin and a coloring agent and a shell in contact with an exterior surface of the core toner particles, wherein the shell forms an essentially continuous layer over at least 20% of the exterior surface of the core toner particles, wherein the shell comprises a second resin, and wherein the core toner particles are produced by a traditional toner production method.

In some aspects, some example embodiments pertain to a toner composition that comprises core toner particles comprising a first resin and a coloring agent and a shell in contact with an exterior surface of the core toner particles, wherein the shell forms an essentially continuous layer over at least 20% of the exterior surface of the core toner particles, wherein the shell comprises a second resin, and wherein the core toner particles have an average degree of roundness of about 0.90 or less. In some embodiments, the shell forms an essentially continuous layer over at least 50%, at least 75%, or at least 90% of the exterior surface of the core toner particles. In some embodiments, the core toner particles have an average degree of roundness of about 0.85 or less, or even about 0.80 or less.

In some aspects, some example embodiments pertain to a toner cartridge removably attachable to an image forming apparatus, the toner cartridge comprising a toner chamber and a core/shell toner composition produced by a process described herein disposed within the toner chamber.

In some aspects, some example embodiments pertain to a toner cartridge removably attachable to an image forming apparatus, the tone cartridge comprising a toner chamber and a core/shell composition as described herein disposed within the toner chamber.

In some aspects, some example embodiments pertain to a method of coating toner particles comprising mixing dry toner particles and a dispersion comprising second particles to coat at least a portion of an exterior surface of the toner particles with an essentially continuous layer of the second particles, wherein the toner particles comprise a first resin and a coloring agent. In some embodiments, the second particles are selected from the group consisting of a wax, charge control agent, resin, metal oxide and combinations thereof.

In some aspects, some example embodiments pertain to a toner composition that comprises core toner particles comprising a first resin and a coloring agent and a shell in contact with an exterior surface of the core toner particles, wherein the shell forms an essentially continuous layer over at least 20% of the exterior surface of the core toner particles, wherein the shell comprises a second resin, and wherein the surface roughness number of the core toner particles prior to coating is less than the surface roughness number of the coated particles.

In some aspects, some example embodiments pertain to a toner composition that comprises core toner particles comprising a first resin and a coloring agent and a shell in contact with an exterior surface of the core toner particles, wherein the shell forms an essentially continuous layer over at least 20% of the exterior surface of the core toner particles, wherein the shell comprises a second resin, and wherein the average degree of roundness of the core toner particles prior to coating is less than the average degree of roundness of the coated particles.

In some aspects, some example embodiments pertain to a method for coating particles that comprises mixing dry first particles and a dispersion comprising second particles to coat at least a portion of an exterior surface of the first particles with an essentially continuous layer of the second particles.

### BRIEF DESCRIPTION OF THE FIGURES

FIG. 1 is a scanning electron microscopy (SEM) of core toner particles produced by traditional toner production methods.

FIG. 2 is an SEM of core/shell toner composition particles produced by one example process of the present disclosure.

FIG. 3 is a transmission electron microscopy (TEM) of a core/shell toner composition particle of FIG. 2 that shows an essentially continuous shell layer formed on the exterior surface of a core toner particle.

FIG. 4 is an SEM of core/shell toner composition particle produced by one example process of the present disclosure.

FIG. 5 is an SEM of core/shell toner composition particles produced by one example process of the present disclosure.

FIG. 6 is an SEM of core/shell toner composition particles produced by one example process of the present disclosure.

FIG. 7 is an SEM of core/shell toner composition particles produced by one example process of the present disclosure.

FIG. 8 is an SEM of a core/shell toner composition particle produced by one example process of the present disclosure.

FIG. 9 is an SEM of core/shell toner composition particles produced by one example process of the present disclosure.

FIG. 10 is an SEM of core/shell toner composition particles produced by one example process of the present disclosure.

FIG. 11 is an SEM of core/shell toner composition particles produced by one example process of the present disclosure.

FIG. 12 is an SEM of core/shell toner composition particles produced by one example process of the present disclosure.

FIG. 13 is an SEM of core/shell toner composition particles produced by one example process of the present disclosure.

### DETAILED DESCRIPTION OF THE INVENTION

Some examples of processes for producing core/shell toner compositions include mixing dry toner particles and a dispersion comprising shell particles to coat at least a portion of the exterior surface of the toner particles with the shell particles. The term dispersion is being used in a broad sense to include, e.g., dispersions, emulsions and suspensions. The shell particles can include, e.g., a wax, charge control agent, metal oxide, resin or a combination thereof. In some embodiments, the shell particles are present, or are coated onto the toner particles, as an essentially continuous layer that covers at least a portion of an exterior surface of the toner particles. In some cases, the processes may facilitate formation of core/shell toner compositions without necessarily requiring the use of complex equipment and corresponding production procedures typically associated with chemically produced toners. By utilizing production equipment currently used by toner manufacturers, the improved processes can produce toners that may exhibit at least some of the properties of chemically produced toners (e.g., low melting core with a higher melting shell, desired surface roughness), while potentially reducing manufacturing and process development costs. The improved processes may also allow for flexibility in the selection of core particle resin and shell particle resin. In other words, the improved processes can be used to produce core/shell toners having numerous combinations of core and shell resins. In addition, the thickness of the shell layer that forms around the core toner particles can be varied by, e.g., adjusting the peripheral speed of the mixer, adjusting the concentration of the shell particles, or the like, or combinations thereof.

The core/shell toner compositions can be formed using core toner particles produced by, e.g., traditional methods (i.e., extrusion, pulverization and classification), chemical methods, or a combination thereof. Generally, toners particles produced by traditional methods are relatively irregular in shape and do not exhibit as high a degree of roundness as compared to chemically prepared toners. In some embodiments, the core toner particles used to form the core/shell toner compositions have an average degree of roundness of about 0.90 or less, about 0.85 or less, or even about 0.80 or less. The average degree of roundness is defined as the peripheral length of a circle equal to the projection area of a particle divided by the peripheral length of the particle projection image. If the toner particles are perfectly spherical, then the average degree of roundness equals 1. While not wanting to be limited by a particular theory, it is believed that during the coating processes the shell particles “fill in” the irregularities on the exterior surface of the core toner particles and form an essentially continuous shell layer over at least a portion of the core toner particles. As a result, the core/shell toner compositions can have a lower shape coefficient number and/or a higher average degree of roundness than the core toner particles prior to coating the core toner particles with the shell layer. For example, in some embodiments, the core/shell toner compositions can have a average degree of roundness that may be in the range of 1% or more, 2.5% or more, 5% or more, or in the range of 5 to 15% greater than the degree of roundness of the core toner particles prior to coating the core toner particles with the shell layer. Further, for example, in some embodiments, the core/shell toner compositions can have a shape coefficient number that may be in the range of 1% or more, 2.5% or more, 5% or more, or in the range of 5 to 40% lower than the shape coefficient number of the core toner particles prior to coating the core toner particles with the shell layer. The shape coefficient is defined as [(maximum diameter/2)²×π]/(projection area). In addition, the core/shell toner compositions can have an average surface roughness number that is higher (i.e., more smooth) than the average surface roughness number of the core toner particles prior to coating the core toner particle with the shell layer. The average surface roughness number (SF1) is defined as Le/Lp, where Le represents the length of the minimum envelope line and Lp represents the peripheral length of each toner particle. If a toner particle has a perfectly smooth surface, then the average surface roughness equals 1.

In addition to coating toner particles, the processes of the present disclosure can be used to coat other core particles to form various core/shell composites. Any suitable core particle can be used including, e.g., particles for powder coating applications, metal particles, resin or polymer particles, and drug or pharmaceutical particles. The skilled artisan will recognize that the selection of the shell particles can be guided by the core particles and the intended application of the core/shell composite.

### Dry Toner Particles

The dry toner particles can be any toner particles suitable for use in electrophotographic imaging processes. The dry toner particles can include a binder resin and one or more additives such as coloring agents, charge control agents, release agents and combinations thereof. The dry toner particles can have any shape including, e.g., round, elliptical, irregular shapes with jagged edges, or a combination thereof. In some embodiments, the dry toner particles can have a larger median volume average particle size than the shell particles and can form the core of the core/shell toner composition. In some embodiments, the dry toner particles can have a median volume average particle size of less than about 30 micrometers. In other embodiments, the dry toner particles can have a median volume average particle size from about 2 micrometers to about 20 micrometers, while in further embodiments the dry toner particles can have a median volume average particle size from about 5 micrometers to about 15 micrometers.

The dry toner particles can include one or more binder resins. Any binder resin suitable for use in electrophotography applications can be used to form the dry toner particles. The binder resin can be a homopolymer, copolymer, block copolymer, or a blend thereof. Useful binder resins include, e.g., styrene resins or homopolymers or copolymers containing styrene or substituted styrene such as polystyrene, poly-α-methylstyrene, chloropolystyrene, styrene-chlorostyrene copolymers, styrene-propylene copolymers, styrene-butadiene copolymers, styrene-vinyl chloride copolymers, styrene-vinyl acetate copolymers, styrene-maleic acid copolymers, styrene-acrylate copolymers, styrene-methacrylate copolymers, styrene-acrylate-methacrylate copolymers, styrene-α-methyl chloroacrylate copolymers and styrene-acrylonitrile-acrylate copolymers, polyester resins, epoxy resins, urethane-modified epoxy resins, silicone-modified epoxy resins, vinyl chloride resins, rosin-modified maleic acid resins, phenyl resins, polyvinyltolulene, polyethylene, polypropylene, ionomer resins, polyurethane resins, polyvinyl acetate, polyvinyl chloride, silicone resins, ketone resins, ethylene-ethyl acrylate copolymers, xylene resins, polyvinyl butyral resins, terpene resins, phenol resins, and aliphatic or alicyclic hydrocarbon resins, and blends and copolymers thereof. Suitable binder resins are also described in U.S. Pat. No. 4,900,647 to Hikake et al., entitled, “Process For Producing Electrophotographic Toner Comprising Micropulverization, Classification, and Smoothing” and U.S. Pat. No. 6,806,011 to Teshima et al., entitled, “Dry Toner For Electrophotography, And Its Production Process”, both of which are incorporated herein by reference.

In some embodiments, the binder resin of the dry toner particles can include a crosslinked styrene copolymer or crosslinked polyester. Useful comonomers that can be copolymerized to form crosslinked styrene copolymers include, e.g., monocarboxylic acids having a double bond or derivatives thereof such as acrylic acid, methyl acrylate, ethyl acrylate, butyl acrylate, dodecyl acrylate, phenyl acrylate, methacrylic acid, methyl methacrylate, ethyl methacrylate, butyl methacrylate, octyl methacrylate, acrylonitrile, meth-acrylonitrile, and acrylamide, dicarboxylic acids having a double bond or derivatives thereof such as maleic acid, butyl maleate, methyl maleate and dimethyl maleate. In addition, a compound having two or more polymerizable double bonds can be used as a crosslinking agent. Useful crosslinking agents include, e.g., aromatic divinyl compounds, carboxylic acid esters having two double bonds, divinyl compounds, and compounds having three or more vinyl groups.

In some embodiments, the binder resin of the dry toner particles can include a polyester resin having a weight-average molecular weight (Mw) from about 3,000 to about 100,000, from about 20,000 to about 80,000, or even from about 30,000 to about 60,000. In other embodiments, the binder resin of the dry toner particles can include a styrene-acrylic resin having a weight-average molecular weight (Mw) from about 3,000 to about 100,000, from about 20,000 to about 80,000, or even from about 30,000 to about 60,000.

The binder resin of the dry toner particles can have any desired glass transition temperature (T_{g}). In some embodiments, the binder resin of the dry toner particles can have a glass transition temperature (T_{g}) from about 40° C. to about 75° C., from about 45° C. to about 70° C., or even from about 50° C. to about 60° C. The skilled artisan will recognize that additional subranges within these explicit ranges are contemplated are within the scope of the present disclosure.

Useful commercially available binder resins are sold under the trade names FINE-TONE by Reichhold (Durham, N.C.), ALMACRYL and ALAMATEX by Image Polymers (Wilmington, Mass.), TUFTONE by Kao (Japan), NIKALITE X by Nippon Carbide (Japan), DIACRON by Dianal (Japan), HIMER by Sanyo-Kasei Co. (Japan) and SKYBON by SK Chemicals (South Korea).

The dry toner particles can include one or more coloring agents. Any coloring agent conventionally used in the preparation of toners can be employed. Useful coloring agents include organic pigments, inorganic pigments, dyes and combinations thereof. Useful pigments include, e.g., carbon black, copper oxide, triiron tetraoxide, manganese dioxide, aniline black, activated carbon, chrome yellow, zinc yellow, cadmium yellow, yellow iron oxide, mineral fast yellow, nickel titanium yellow, naval yellow, naphthol yellow S, hansa yellow G, hansa yellow 10G, benzidine yellow G, benzidine yellow GR, quinoline yellow lake, permanent yellow NCG, tartrazine lake, red chrome yellow, molybdenum orange, permanent orange GTR, pyrazolone orange, vulcan orange, indanthrene brilliant orange RK, benzidine orange G and indanthrene brilliant orange GKM, red iron oxide, cadmium red, red lead, mercury sulfide, cadmium, permanent red 4R, lithol red, pyrazolone red, watchung red, calcium salt, lake red D, brilliant carmine 6B, eosine lake, rhodamine lake B, alizarine lake, brilliant carmine 3B, manganese violet, fast violet B, methyl violet lake, prussian blue, cobalt blue, alkali blue lake, victoria blue lake, phthalocyanine blue, metal-free phthalocyanine blue, a partially chlorinated pigment of phthalocyanine blue, fast sky blue, indanthrene blue BG, chrome green, chromium oxide, pigment green B, malachite green lake, final yellow green G, zinc white, titanium oxide, antimony white, zinc sulfide, barite powders, barium carbonate, clay, silica, white carbon, talc, alumina white and combinations thereof. Useful dyes include, e.g., nigrosine, methylene blue, rose bengale, quinoline yellow, ultramarine blue and combinations thereof. Useful coloring agents are further described in U.S. Pat. No. 4,839,255 to Hyosu et al., entitled, “Process For Producing Toner For Developing Electrostatic Images,” U.S. Pat. No. 6,806,011 to Teshima et al., entitled, “Dry Toner For Electrophotography, And Its Production Process,” U.S. Pat. No. 6,936,390 to Nanya et al., entitled, “Toner, Method Of Producing Same And Image Forming Device,” and U.S. Pat. No. 7,217,488 to Mikuriya et al., entitled, “Toner Comprising Core Layer And Shell Layer”, all of which are incorporated herein by reference.

The coloring agent(s) can be present in the dry toner particles at a concentration of from about 1 percent by weight to about 20 percent by weight, or even from about 2 percent by weight to about 10 percent by weight.

Useful commercially available coloring agents are sold under the trade names HOSTACOPY by Clariant Corporation (Switzerland), LUPRETON and NEOPIN by BASF (Germany), IGATONE by Ciba (Switzerland), and SUNSPERSE, SUNBRITE, and SUNFAST by Sun Chemical (Cincinnati, Ohio).

One or more releasing agents can be incorporated into the dry toner particles. Useful releasing agents include, e.g., paraffin wax, polyolefin wax, carnuba wax, sasol wax, rice wax, candelilla wax, hohoba wax, beeswax, modified wax having an aromatic group, hydrocarbon compounds having an alicyclic group, natural wax, long-chain carboxylic acids having a hydrocarbon long chain with at least 12 carbon atoms or their esters, metal salts of fatty acids, fatty acid amides, fatty acid bisamides and combinations thereof. In some embodiments, the releasing agent can be a wax having a melting point from about 40° C. to about 160° C., from about 50° C. to about 150° C., or even from 60° C. to about 90° C. Useful releasing agents are further described in U.S. Pat. No. 4,839,255 to Hyosu et al., entitled, “Process For Producing Toner For Developing Electrostatic Images,” and U.S. Pat. No. 6,806,011 to Teshima et al., entitled, “Dry Toner For Electrophotography, And Its Production Process”, both of which are incorporated herein by reference.

The releasing agent(s) can be present in the dry toner particles at a concentration of from about 0.5 percent by weight to about 20 percent by weight, from about 2 percent by weight to about 10 percent by weight, or even from 3 percent by weight to about 7 percent by weight.

Useful commercially available releasing agents are sold under the trade names LICOWAX, CERIDUST, LICOLUB, LICOMONT and TONERWAX by Clariant Corporation (Switzerland), HIWAX and EXCEREX by Image Polymers (Wilmington, Mass.), WE series by NOF Corporation (Japan), and POLYWAX, UNILIN and UNICID by Baker Hughes (Sugar Land, Tex.).

One or more charge control agents can be incorporated into the dry toner particles. The charge control agents can be organic charge control agents, inorganic charge control agents, or a combination thereof. Useful charge control agents are described in U.S. Pat. No. 6,806,011 to Teshima et al., entitled, “Dry Toner For Electrophotography, And Its Production Process,” and U.S. Pat. No. 6,936,390 to Nanya et al., entitled, “Toner, Method Of Producing Same And Image Forming Device”, both of which are incorporated herein by reference. The charge control agent(s) can be present in the dry toner particles at a concentration of from about 0.1% by weight to about 5% by weight, or even from about 1% by weight to about 3% by weight.

The charging properties and fluidity of the toner particles can be varied by adding one or more external additives to the exterior surface of the toner particles. Suitable flow enhancing additives include, e.g., inorganic oxide particles (e.g., silica particles, alumina particles, titanium particles), metallic salts of stearic acid (e.g., aluminum stearate particles, zinc stearate particles), inorganic titanate particles (e.g., strontium titanate particles, zinc titanate particles) and combinations thereof. Such external additives may be added before and/or after the formation of the shell layer. Some examples of useful flow enhancing agents are described in U.S. Pat. No. 6,806,011 to Teshima et al., entitled, “Dry Toner For Electrophotography, And Its Production Process,” and U.S. Pat. No. 6,936,390 to Nanya et al., entitled, “Toner, Method Of Producing Same And Image Forming Device”, both of which are incorporated herein.

The dry toner particles employed in the processes of the present disclosure can be produced by any appropriate method including, e.g., chemical methods, traditional methods and combinations thereof. In some embodiments, the dry toner particles can be produced by mixing a binder resin and an additive (e.g., a coloring agent, releasing agent or combination thereof) to form a binder/additive composition, kneading the binder/additive composition in an extruder, grinding the resulting binder/additive composition to obtain particles, and classifying the particles. Optionally, one or more external additives can then be added to the exterior surface of the classified particles. Methods for producing toner particles are generally described in U.S. Pat. No. 4,900,647 to Hikake et al., entitled, “Process For Producing Electrophotographic Toner Comprising Micropulverization, Classification, and Smoothing”, U.S. Pat. No. 4,839,255 to Hyosu et al., entitled, “Process For Producing Toner For Developing Electrostatic Images”, U.S. Pat. No. 6,503,679 to Aoki et al., entitled, “Color Toner For Image Developing An Electrostatic Image”, and U.S. Pat. No. 6,806,011 to Teshima et al., entitled, “Dry Toner For Electrophotography, and Its Production Process”, all of which are hereby incorporated by reference herein.

### Dispersions

As described above, a dispersion can be mixed with dry toner particles to facilitate forming a shell layer or coating on the exterior surface of the toner particles. Generally, the dispersion comprises shell particles in aqueous or non-aqueous dispersants. The dispersions can also include dispersion aids, stabilizers or a combination thereof. In one embodiment, the dispersion can include styrene acrylic particles dispersed in a mixture of water and ammonia. Due to the presence of the shell particles in “wet” state, the resulting shell coating or layer forms as an essentially continuous layer over at least a portion of the exterior surface of the toner particles. In contrast, mixing dry toner particles with dry shell particles typically results in the impaction of individual or discrete shell particles on the surface of the toner particles and does not form a continuous layer or coating.

The shell particles of the dispersion can be any particles that can be dispersed in an aqueous or non-aqueous dispersant including, e.g., a wax, charge control agent, resin, metal oxide or a combination thereof. In embodiments where the shell particles include a resin, the resin can be a homopolymer, copolymer, block copolymer, or a blend thereof. Useful resins for the shell particles include, e.g., styrene resins or homopolymers or copolymers containing styrene or substituted styrene such as polystyrene, poly-α-methylstyrene, chloropolystyrene, styrene-chlorostyrene copolymers, styrene-propylene copolymers, styrene-butadiene copolymers, styrene-vinyl chloride copolymers, styrene-vinyl acetate copolymers, styrene-maleic acid copolymers, styrene-acrylate copolymers, styrene-methacrylate copolymers, styrene-acrylate-methacrylate copolymers, styrene-α-methyl chloroacrylate copolymers and styrene-acrylonitrile-acrylate copolymers, polyester resins, epoxy resins, urethane-modified epoxy resins, silicone-modified epoxy resins, vinyl chloride resins, rosin-modified maleic acid resins, phenyl resins, polyvinyltolulene, polyethylene, polypropylene, ionomer resins, polyurethane resins, polyvinyl acetate, polyvinyl chloride, silicone resins, ketone resins, ethylene-ethyl acrylate copolymers, xylene resins, polyvinyl butyral resins, terpene resins, phenol resins, and aliphatic or alicyclic hydrocarbon resins, and blends and copolymers thereof.

The resin or resins employed as the shell particles can have any desired glass transition temperature (T_{g}). In some embodiments, the glass transition temperature (T_{g}) of the resin employed as the shell particles can be from about 50° C. to about 120° C., from about 60° C. to about 85° C., or even from about 65° C. to about 75° C. The skilled artisan will recognize that additional subranges within these explicit ranges are contemplated and are within the scope of the present disclosure. In addition, in one embodiment the glass transition temperature of the resin of the core toner particles can be equal to or lower than the glass transition temperature of the resin employed as the shell particles. In other embodiments, the glass transition temperature of the core toner resin can be greater than the glass transition temperature of the resin employed as the shell particles.

The dispersant can be any liquid or liquids that can disperse the shell particles. In some embodiments, the dispersant comprises water, while in other embodiments the dispersant comprises a mixture of water and an organic liquid such as an alcohol. The dispersion may also include one or more dispersion aids such as ammonia. In some embodiments, the dispersions can comprise from about 30% by weight to about 60% by weight solids, while in other embodiments the dispersions can comprises from about 40% by weight to about 50% by weight solids.

Useful commercially available dispersions are sold under the trade names AROLON by Reichhold (Durham, N.C.), LUCIDENE by Rohm and Haas (Philadelphia, Pa.), ARALDITE by Huntsman (Salt Lake City, Utah) and UNITHOX and PETROLITE by Baker Hughes (Sugar Land, Tex.).

### Processing to Form Core/Shell Compositions

The core/shell compositions of the present disclosure comprise a core particle and a shell layer in contact with an exterior surface of the core particle. In some embodiments, the core particles can comprise a core toner particle. To form the core/shell toner compositions, dry toner particles can be mixed with a dispersion that comprises shell particles. The dry toner particles and the dispersion can be mixed in any appropriate mixing device including, e.g., a vertical, high intensity mixer or a horizontal, medium intensity mixer. Suitable horizontal, medium intensity mixers include, e.g., an M-5 mixer manufactured by Littleford-Day. Suitable vertical, high intensity mixing devices include, e.g., a Henschel mixer. Generally, the mixing device can facilitate contact between the toner particles and the dispersion such that the shell particles in the dispersion contact the toner particles and form an essentially continuous coating or layer over at least a portion of the toner particles.

In some embodiments, the dry toner particles can be added to the mixing device prior to the addition of the dispersion, while in other embodiments the dry toner particles can be added to mixing device simultaneously with the dispersion. The dispersion can be added to the mixing device by any suitable method including, e.g., pouring, injecting via a nozzle or a combination thereof. During addition of the dispersion to the mixing device, the mixing blade of the mixing device can be rotated at a relatively low peripheral speed (e.g., from about 2 meters/second to about 10 meters/second). Once the addition of the dispersion is completed, the peripheral speed of the mixing device can be increased. In some embodiments, the peripheral speed can be increased to a range from about 20 meters/second to about 60 meters/second after the addition of the dispersion. Mixing the toner particles and the dispersion at relatively higher peripheral speeds can form core/shell toner composition particles that have desirable surface roughness properties (i.e., are more smooth).

In addition, allowing the temperature of the tone particle/dispersion mixture to approach the glass transition temperature of the core toner particle resin can produce core/shell toner composition particles that have a higher average degree of roundness. The temperature of the mixture can be controlled by, e.g., slowing down the peripheral speed of the mixing device, applying cooling or heating means (e.g., heating coils, cooling jackets) to an exterior surface of the mixing device, or a combination thereof. In some embodiment, the toner particles and the dispersion can be mixed under conditions sufficient to raise a temperature of the mixture to within about plus or minus 5° C. of the glass transition temperature of the core tone particle resin. In other embodiments, the toner particles and the dispersion can be mixed under conditions sufficient to raise a temperature of the mixture to within about plus or minus 3° C. of the glass transition temperature of the core toner particle resin.

In some embodiments, the mixing device can be “pre-conditioned” prior to mixing the dry toner particles and the dispersion. In general, pre-conditioning includes mixing a relatively small batch of the toner particles and the dispersion in the mixing device to coat the inner surfaces of the mixing device with a thin layer of the toner particle/dispersion mixture. The thin coating that is generated during the pre-conditioning step is not removed or cleaned off the inner surfaces of the mixing device prior to the introduction of the materials for a subsequent batch. While not wanting to be limited by a particular theory, it is believed that pre-conditioning prevents the toner particles from adhering to the inner surfaces of the mixing device during the production of the core/shell toner compositions, which facilitates better mixing of the toner particles and the dispersion.

The toner particles and the dispersion can be mixed for any appropriate time period. The skilled artisan can determine appropriate mixing times based on factors such as batch size, peripheral mixing speed, and desired coating properties (i.e., fully coated particles, partially coated particles, etc.). In some embodiments, the toner particles and the dispersion can be mixed for about 5 minutes to about minutes 90, from about 15 minutes to about 80 minutes, or even from about 25 minutes to about 70 minutes.

The shell particles can be added to the mixing device at any desired concentration. Adjusting the concentration of the shell particles relative to the dry toner particles can alter the thickness of the resulting shell layer that forms on the toner particles. In general, lower concentrations of shell particles relative to the toner particles results in formation of a thinner shell layer than compositions produced using relatively higher concentrations of shell particles. In some embodiments, the shell particles can be present at a concentration of from about 0.1% by weight to about 20% by weight based on the weight of dry toner particles. In other embodiments, the shell particles can be present at a concentration of from about 1% by weight to about 15% by weight, or even from about 5% by weight to about 10% by weight, based on the weight of the dry toner particles. The skilled artisan will recognize that additional subranges within these explicit ranges are contemplated and are within the scope of the present disclosure.

The percentage of the exterior surface of the toner particles that are coated with an essentially continuous layer of the shell particles can be adjusted by varying, e.g., the concentration of the shell particles, the mixing time, the mixing speed or a combination thereof. In some embodiments, the shell particles form an essentially continuous layer over at least 20% or at least 50% of the exterior surface of the toner particles, while in other embodiments the shell particles form an essentially continuous layer over at least 75% of the exterior surface of the toner particles. In further embodiments the shell particles form an essentially continuous layer over at least 90% or 95% of the exterior surface of the toner particles. In still further embodiments, the shell particles can form an essentially continuous layer over the entire exterior surface of the core toner particles.

### Articles Containing the Core/Shell Compositions

The core/shell toner compositions of the present disclosure can be disposed in any suitable article including, e.g., a bag, bottle, toner cartridge that is removeably attachable to an image forming device, or a combination thereof. Toner cartridges generally include a toner chamber that is adapted to hold a toner composition and a toner discharge port. Toner cartridges are further described in U.S. Pat. No. 6,628,910 to Tanisawa et al., entitled, “Toner Cartridge For Image Forming Apparatus”, U.S. Pat. No. 5,907,756 to Shirota et al., entitled, “Toner Replenishment Device and Toner Bottle”, and U.S. Pat. No. 6,370,349 to Tsuji et al., entitled, “Toner Storing Container And Toner Replenishing Device Therewith”, all of which are incorporated herein by reference.

The embodiments above are intended to be illustrative and not limiting. Although the present invention has been described with reference to particular embodiments, those skilled in the art will recognize that changes may be made in form and detail without departing from the spirit and scope of the invention.

The following examples further illustrate aspects of the present invention.

### EXAMPLES

Table 1 lists the formulations of the core toner particles used in Examples 1-6. All values reported in Table 1 are in % by weight. Table 2 lists the surface roughness number, average degree of roundness and shape coefficient number for the core toner particles used in Examples 1-11. Table 3 lists the surface roughness number, average degree of roundness and shape coefficient number for the core/shell toner compositions formed in Examples 1-11, as well as the surface roughness number, average degree of roundness and shape coefficient number for a comparative composition. The comparative composition is a commercially available chemically prepared toner.

The surface roughness number, average degree of roundness and shape coefficient number were measured by imaging the particles using a Hitachi S-3200N SEM. The SEM images were obtained using an accelerating voltage of 10 KV, a working distance of 15 mm and a magnification of 3500. The resulting SEM images were analyzed using Noran Voyager feature sizing software to yield the reported values.

TABLE 1

| | Example | | | | | |
|---|---|---|---|---|---|---|
| | 1 | 2 | 3 | 4 | 5 | 6 |
| Material | % | | | | | |
| Fine-Tone 382-ES | 81.5 | | | | | |
| Fine-Tone 382-ES-HMW | | 81.5 | | | | |
| B1552 | | | 81.5 | | | |
| Fine-Tone CX-157 | | | | 81.5 | | |
| Skybon ET-S205 | | | | | 89 | |
| Fine-Tone T-RM-12 | | | | | | 89 |
| Hostacopy BG-C 101 | 12.5 | 12.5 | 12.5 | 12.5 | | |
| Toner Cyan BG | | | | | 5 | 5 |
| Licowax F | 4 | 4 | 4 | 4 | 4 | 4 |
| Ceridust 5551 | 2 | 2 | 2 | 2 | 2 | 2 |

TABLE 2

| | Surface Roughness | Average Degree of | Shape Coefficient |
|---|---|---|---|
| Example | Number (SF1) | Roundness | Number |
| 1 | 0.80 | 0.73 | 1.53 |
| 2 | 0.80 | 0.73 | 1.63 |
| 3 | 0.79 | 0.73 | 1.54 |
| 4 | 0.85 | 0.79 | 1.36 |
| 5 | 0.84 | 0.77 | 1.61 |
| 6 | 0.80 | 0.72 | 1.69 |
| 7 | 0.79 | 0.73 | 1.54 |
| 8 | 0.79 | 0.74 | 1.66 |
| 9 | 0.80 | 0.73 | 1.63 |
| 10 | 0.82 | 0.77 | 1.55 |
| 11 | 0.82 | 0.77 | 1.55 |

TABLE 3

| | | | Shape |
|---|---|---|---|
| | Surface Roughness | Average Degree of | Coefficient |
| Example | Number (SF1) | Roundness | Number |
| 1 | 0.82 | 0.80 | 1.27 |
| 2 | 0.80 | 0.74 | 1.58 |
| 3 | 0.82 | 0.77 | 1.44 |
| 4 | 0.83 | 0.79 | 1.29 |
| 5 | 0.81 | 0.76 | 1.49 |
| 6 | 0.84 | 0.81 | 1.26 |
| 7 | 0.80 | 0.76 | 1.42 |
| 8 | 0.83 | 0.77 | 1.63 |
| 9 | 0.81 | 0.77 | 1.43 |
| 10 | 0.83 | 0.77 | 1.59 |
| 11 | 0.81 | 0.75 | 1.56 |
| comparative | 0.84 | 0.81 | 1.36 |
| example | | | |

### Example 1

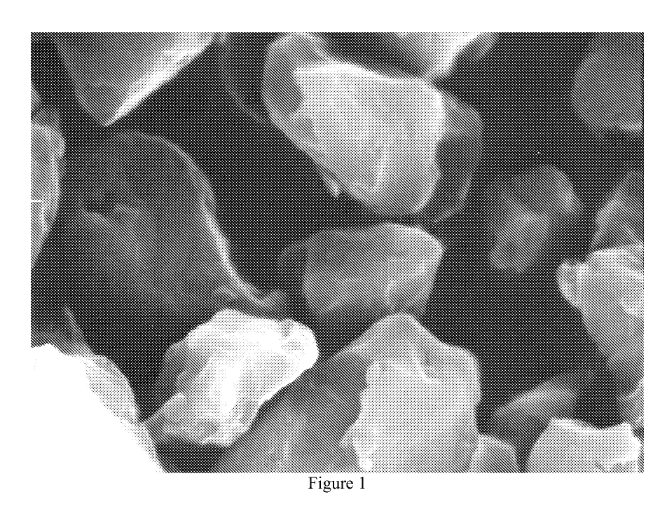

Core toner particles were prepared by premixing 2037.5 g of FINE-TONE T-382-ES polyester resin (manufactured by Reichhold, T_{g}=56° C.), 312.5 g HOSTACOPY BG-cyan pigment (manufactured by Clariant Corporation), 100 g LICOWAX F ester wax (manufactured by Clariant Corporation), and 50 g CERIDUST 5551 ester wax (manufactured by Clariant Corporation) in a 9-liter Henschel FM-10 mixer at a peripheral speed of 40 meters/second for approximately 1 minute. The resulting mixture was kneaded in a PCS-30 Ko-Kneader single screw extruder (manufactured by Buss) and crushed in an RP-6-K115 Disintegrator hammer mill (manufactured by Rietz). The resulting particles were pulverized by a 100 AFG jet mill (manufactured by Hosokawa Alpine AG) to yield fine toner particles. The fine toner particles were minutely classified by an A-12 Acucut air classifier (manufactured by Donaldson Corporation) to yield cyan toner particles having a median volume average particle size of 7.0 μm. The median volume average particle size of the particles was determined by a Multisizer IIe Coulter Counter (Manufactured by Coulter Electronics). The resulting core toner particles are shown in FIG. 1.

To prepare a sample of particles for the Multisizer IIe Coulter Counter a spatula tip amount of toner was placed in a plastic 2 mL vial, 3-4 drops of Coulter IA dispersant solution was added directly onto the toner, and then the vial was filled ¾ full with distilled water. The sample was then mixed using a plastic pipette (i.e., slowly taking sample into the pipette and then pushing the sample out from the pipette and back into the vial). Care was taken during mixing so as to avoid creating any air bubbles in the sample. The vial containing the sample was then placed in an ultrasonic bath for 30 seconds. After the mixing and bathing steps, a pipette was used to add some of the sample to the beaker in the sampling stand of the counter. The door on the counter was closed on the sampling stand and the percentage particles was read off the control device. The test for median volume average particle size was then run using the counter when the sample was determined to be about 10-20% particles. The operating procedure for all particle size measurements requires the utilization of an orifice tube with an aperture size of 100 μm, and a 100,000-particle count per test. Furthermore, a background count was conducted before every test to verify the absence of any interference due to Isoton II solution contamination or other outside source contamination. The background count was conducted using clean Isoton II solution and performing a count for 30 seconds. The system was considered acceptable if 30 particles or less were counted.

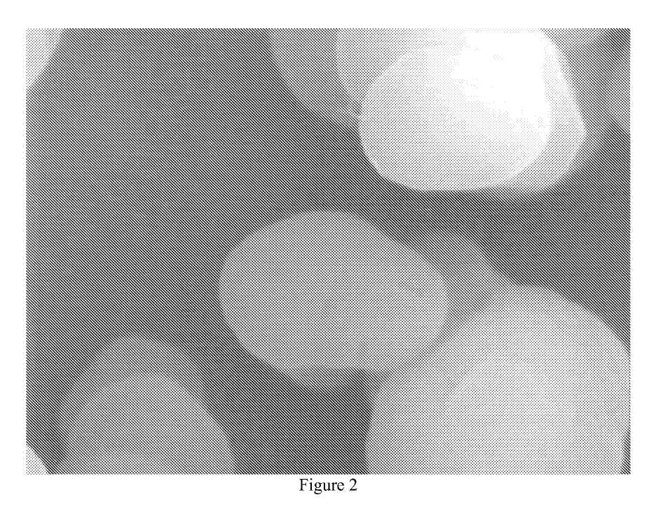

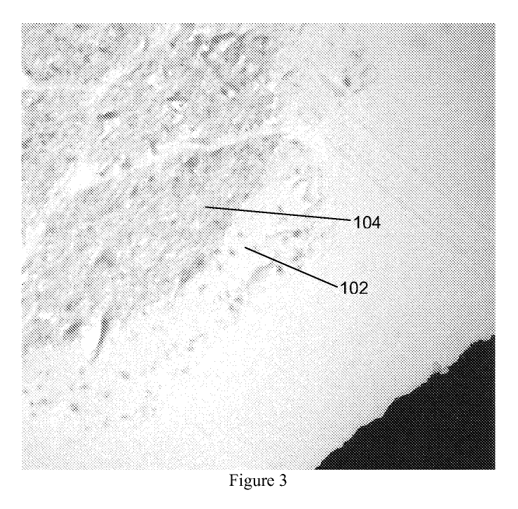

786 g of the core toner particles produced above were introduced into a Henschel mixer while maintaining a peripheral speed of 6.7 meters/second. 38.8 g of AROLON 835 styrene acrylic emulsion (manufactured by Reichhold, 44-46% solids by weight) was then poured through the Henschel mixer cover port, and the Henschel mixer peripheral speed was increased to 40 meters/second. The resulting toner particle/dispersion mixture was mixed at a peripheral speed of 40 meters/second for 5 minutes, at which point the peripheral speed of the Henschel mixer was reduced to 6.7 meters/second, and a second addition 38.8 g of AROLON 845 was poured into the Henschel mixer through the cover port. This process was repeated for a total of six additions of AROLON 845, resulting in 232.8 g of AROLON 845 being added into the Henschel mixer. After the last addition of AROLON 845, the peripheral speed of the Henschel mixer was maintained at 40 meters/second for 60 minutes. During this time, the mixing conditions were controlled such that the maximum temperature of the mixture did not exceed about 58° C. The resulting mixture was allowed to dry in ambient conditions for 24 hours. The resulting core/shell toner composition particles are shown FIG. 2. FIG. 3 is a cross section of the particles of FIG. 2 and shows the essentially continuous shell 102 formed over an exterior surface of a core toner particle 104.

The toner particles illustrated in FIG. 3 were visualized via TEM imaging. To prepare the particles for TEM imaging, a small amount of toner was embedded in Extec epoxy and allowed to cure overnight at room temperature. Thin sections (e.g., about 80-90 nm thick) were cut on a Reicher-Jung Ultracut E Ultramicrotome at room temperature using a diamond knife. Samples were analyzed on a Philips CM120 transmission electron microscope (TEM) operated at 100 kV and digital images were recorded using a 2 k×2 k bottom mount digital camera.

### Example 2

Core toner particles were prepared in the same manner as described in Example 1, except FINE-TONE T-382-ES-HMW polyester resin (Reichhold, T_{g}=58° C., T_{1/2}=117° C.) was used instead of FINE-TONE T-382.

A small “pre-conditioning” batch was mixed inside the Henschel mixer by introducing 576 g of the core toner particles into the mixer. While mixing at a peripheral speed of 6.7 meters/second, 87.4 g of AROLON 860 styrene acrylic emulsion (manufactured by Reichhold, 44-46% solids) was introduced into the mixer through a nozzle attached to the port of the mixer cover. Subsequently, the peripheral speed was increased to 40 meters/second and the mixture was stirred for 30 minutes. The “pre-conditioning” batch coated the inner surfaces of the mixer and was not removed.

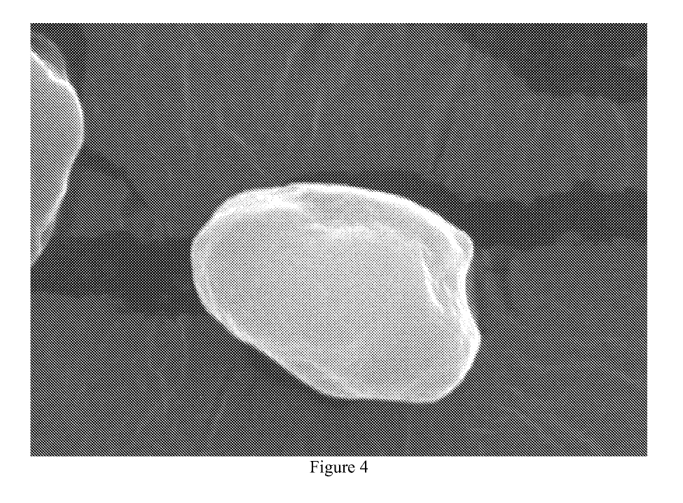

768 g of the core toner particles were then added to the mixer and 116.5 g of AROLON 860 styrene acrylic emulsion was introduced into the mixer through a nozzle attached to the port of the mixer cover while mixing at a peripheral speed of 6.7 meters/second. Subsequently, the peripheral speed of the mixer was increased to 40 meters/second and the mixture was mixed for 45 minutes. During this time, the mixing conditions were controlled such that the maximum temperature of the mixture did not exceed about 56° C. The resulting core/shell toner composition particles are shown in FIG. 4.

### Example 3

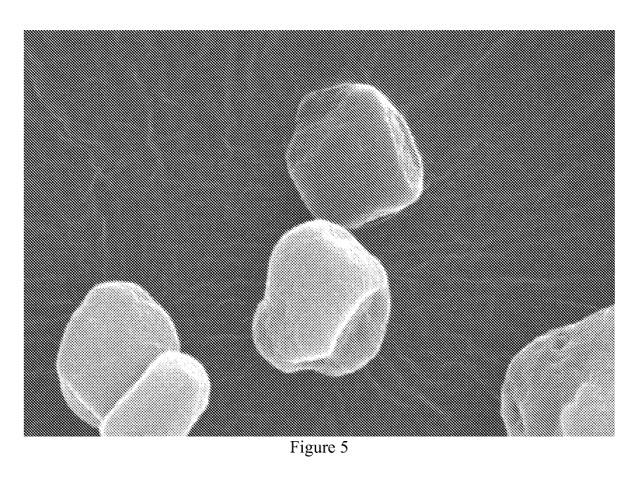

Core/shell toner composition particles were prepared in the same manner as described in Example 2, except a styrene acrylic resin, ALMACRYL B1552 (Image Polymers, T_{g}=53° C., T_{1/2}=118° C.), was used instead of FINE-TONE T-382-ES-HMW to produce the core toner particles. During mixing, the conditions were controlled such that the maximum temperature of the mixture did not exceed about 54° C. The resulting core/shell toner composition particles are shown in FIG. 5.

### Example 4

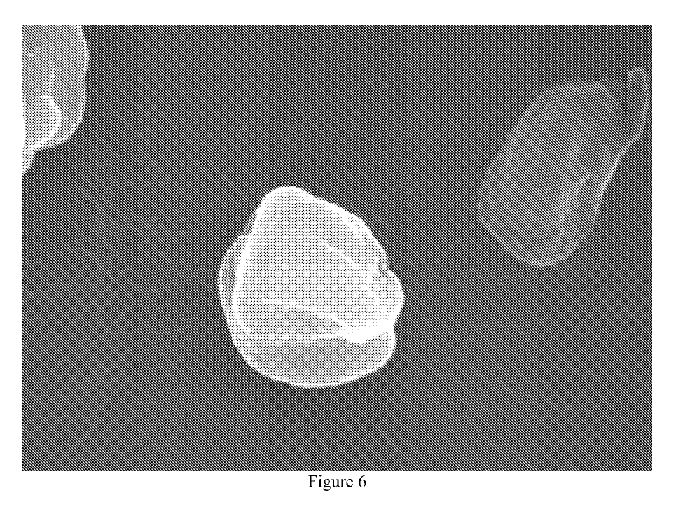

Core/shell toner composition particles were prepared in the same manner as described in Example 2, except FINE-TONE CX-157 polyester resin (Reichhold, T_{g}=58° C., T_{1/2}=145° C.) was used instead of FINE-TONE T-382-ES-HMW to produce the core toner particles. During mixing, the conditions were controlled such that the maximum temperature of the mixture did not exceed about 58° C. The resulting core/shell toner composition particles are shown in FIG. 6.

### Example 5

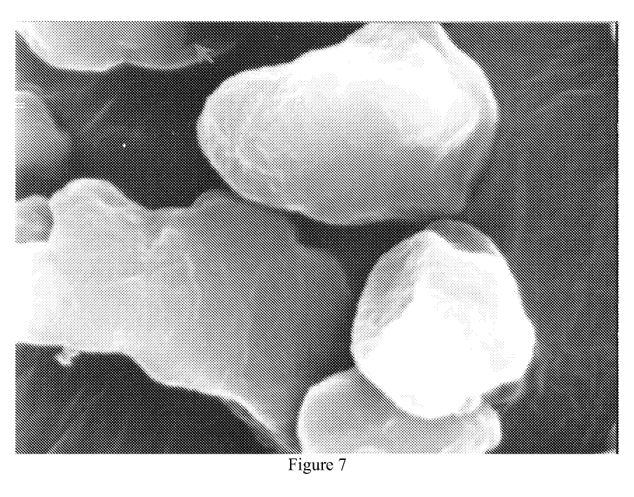

Core/shell toner composition particles were prepared in the same manner as described in Example 2, except SKYBON ET-S205 polyester resin (SK Chemicals, T_{g}=70° C., T_{1/2}=191° C.) was used instead of FINE-TONE T-382-ES-HMW, and 125 g Toner Cyan BG (Clariant Corporation) was used instead of HOSTACOPY BG-C 101 to produce the core toner particles. During mixing, the conditions were controlled such that the maximum temperature of the mixture did not exceed about 58° C. The resulting particles are shown in FIG. 7.

### Example 6

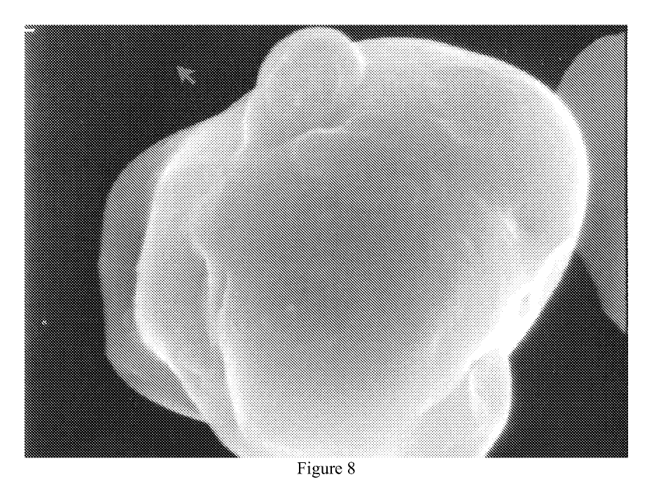

Core/shell toner composition particles were prepared in the same manner as Example 5, except FINE-TONE T-RM-12 polyester (manufactured by Reichhold, T_{g}=45° C.) was used instead of SKYBON ET-S205 to produce the core toner particles. During mixing, the conditions were controlled such that the maximum temperature of the mixture did not exceed about 45° C. The resulting core/shell toner composition particles are shown in FIG. 8.

### Example 7

Core toner particles were prepared by premixing 2037.5 g of ALMACRYL B1552 styrene acrylic resin, (manufactured by Image Polymers, T_{g}=53° C., T_{1/2}=118° C.), 312.5 g of HOSTACOPY BG-C-101 cyan pigment (manufactured by Clariant Corporation), 100 g of LICOWAX F ester wax (manufactured by Clariant Corporation), and 50 g of a CERIDUST 5551 ester wax (manufactured by Clariant Corporation) in a 9-liter Henschel mixer at a peripheral speed of 40 meters/second for 60 seconds. The resulting mixture was kneaded in a Ko-Kneader single screw extruder and primarily crushed in a hammer mill. The resulting particles were pulverized by a 100 AFG jet mill to yield fine toner particles. The fine toner particles were minutely classified by an A-12 Acucut air classifier to yield cyan toner particles having a median volume average particle size of 7.0 μm. The median volume average particle size of the particles was determined by a Multisizer II Coulter Counter.

A small “pre-conditioning” batch was mixed inside the Henschel mixer by introducing 576 g of the core toner particles into the mixer. While mixing at a peripheral speed of 6.7 meters/second, 25 g of PETROLITE D-1038 aqueous ethoxylate dispersion (manufactured by Baker Hughes, MP=71° C.) was introduced into the mixer through a nozzle attached to the port of the mixer cover. Subsequently, 50.7 g of AROLON 860 styrene acrylic emulsion (manufactured by Reichhold, 44-46% solids) was introduced into the mixer through a nozzle attached to the port of the mixer cover. After the addition of the AROLON 860, the peripheral speed of the mixer was increased to 40 meters/second and the mixture was mixed for 30 minutes. The “pre-conditioning” batch coated the inner surfaces of the mixer and was not removed.

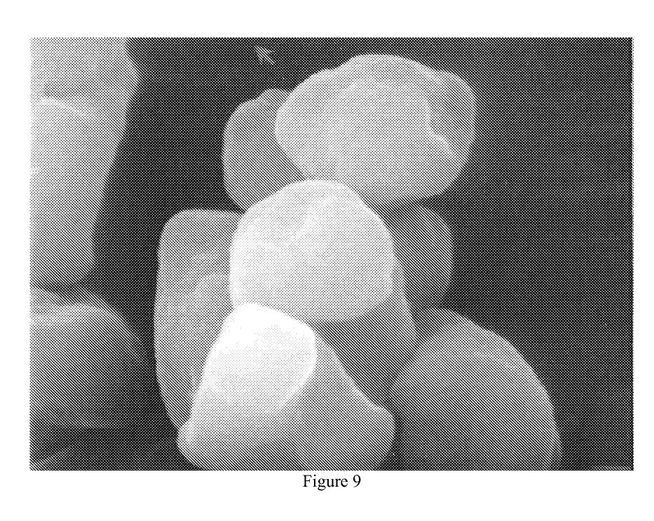

768 g of the core toner particles were added to the mixer and 100 g PETROLITE D-1038 was introduced into the mixer through a nozzle attached to the port of the mixer cover while mixing at a peripheral speed of 6.7 meters/second. Subsequently, 116.5 g of AROLON 860 was introduced into the mixer through a nozzle attached to the port of the mixer cover while mixing at a peripheral speed of 6.7 meters/second. After the addition of the AROLON 860, the peripheral speed of the mixer was increased to 40 meters/second and the mixture was mixed for 45 minutes. During this time, the conditions were controlled such that the maximum temperature of the mixture did not exceed about 56° C. The resulting particles are expected have a core/ethoxylate/shell structure. The resulting particles are shown in FIG. 9.

### Example 8

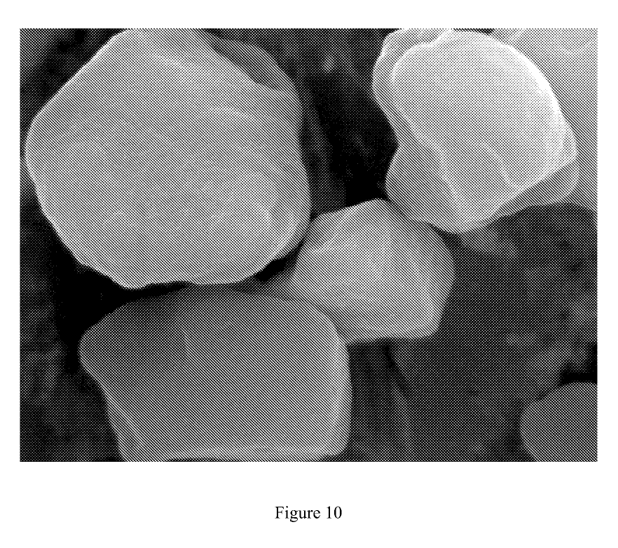

Core/shell toner composition particles were prepared in the same manner as described in Example 2, except ALMACRYL B1539 styrene acrylic resin containing 8% polypropylene wax (Image Polymers, T_{g}=59° C., T_{1/2}=141° C.) was used instead of FINE-TONE T-382-ES-HMW polyester resin to produce the core toner particles. The mixing conditions were controlled such that the maximum temperature of the mixture did not exceed about 58° C. The resulting core/shell particles are shown in FIG. 10.

### Example 9

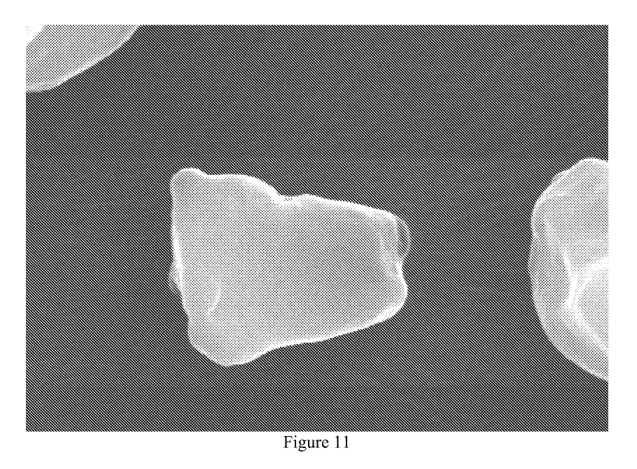

Core/shell toner composition particles were prepared in the same manner as described in Example 2, except LUCIDENE 4015 Plus styrene acrylic emulsion (Rohm and Haas, T_{g}=95° C.) was used instead of AROLON 860. The mixing conditions were controlled such that the maximum temperature of the mixture did not exceed about 58° C. The resulting core/shell particles are shown in FIG. 11.

### Example 10

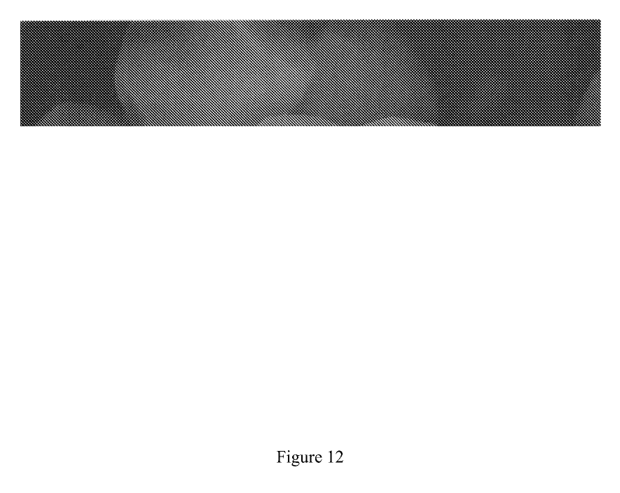

Core/shell toner composition particles were prepared in the same manner as described in Example 2, except ALMACRYL B1552 styrene acrylic resin (Image Polymers, T_{g}=53° C., T_{1/2}=118° C.) was used instead of FINE-TONE T-382-ES-HMW to produce the core toner particles. The mixing conditions were controlled such that the maximum temperature of the mixture did not exceed a temperature of about 51° C. The resulting core/shell particles are shown in FIG. 12.

### Example 11

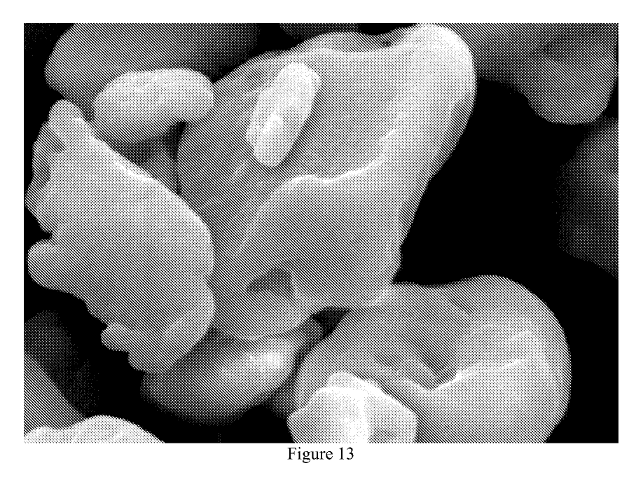

Core/shell toner particles were prepared in the same manner as described in Example 2, except PETROLITE D-800 aqueous wax dispersion (Baker Hughes, MP=64° C.) was used instead of AROLON 860 to coat the base toner particles. The mixing conditions were controlled such that the maximum temperature of the mixture did not exceed about 52° C. The resulting particles are shown in FIG. 13.

What is claimed is:

1. A method for coating toner particles comprising:
mixing dry toner particles and a dispersion comprising shell particles to coat at least a portion of an exterior surface of the toner particles with an essentially continuous layer of the shell particles, wherein the toner particles comprise a first resin and a coloring agent, and wherein the shell particles comprise a second resin.

2. The method of claim 1, wherein the glass transition temperature (T_{g}) of the first resin is equal to or lower than the glass transition temperature (T_{g}) of the second resin.

3. The method of claim 1, wherein the glass transition temperature (T_{g}) of the first resin is higher than the glass transition temperature (T_{g}) of the second resin.

4. The method of claim 1, wherein the dry toner particles have an average particle size by volume from about 5 micrometers to about 10 micrometers.

5. The method of claim 1, wherein the dry toner particles have an average particle size by volume from about 2 micrometers to about 20 micrometers.

6. The method of claim 1, wherein mixing dry toner particles and a dispersion defines a mixture, and wherein the shell particles are present in the mixture at a concentration of from about 0.1% by weight to about 20% by weight based on the weight of the dry toner particles.

7. The method of claim 1, wherein mixing dry toner particles and a dispersion defines a mixture, and wherein the shell particles are present in the mixture at a concentration of from about 1% by weight to about 15% by weight based on the weight of the dry toner particles.

8. The method of claim 1, wherein mixing dry toner particles and a dispersion defines a mixture, and wherein the shell particles are present in the mixture at a concentration of from about 5% by weight to about 10% by weight based on the weight of the dry toner particles.

9. The method of claim 1, wherein the shell particles form an essentially continuous layer over at least 20% of the exterior surface of the toner particles.

10. The method of claim 1, wherein the shell particles form an essentially continuous layer over at least 50% of the exterior surface of the toner particles.

11. The method of claim 1, wherein the shell particles form an essentially continuous layer over at least 75% of the exterior surface of the toner particles.

12. The method of claim 1, wherein the shell particles form an essentially continuous layer over at least 90% of the exterior surface of the toner particles.

13. The method of claim 1, wherein the first resin is selected from the group consisting of polyester resins, styrene acrylic copolymers, polystyrene, hydrogenated styrene resins, styrene isobutylene copolymers, ABS resins, ASA resins, AS resins, AAS resins, ACS resins, AES resins, styrene propylene copolymers, styrene butadiene copolymers, (meth)acrylic resins, polyethylene, polypropylene, polyurethane resins, polyamide resins, silicone resins, and blends and copolymers thereof.

14. The method of claim 13, wherein the first resin has a glass transition temperature (T_{g}) from about 40° C. to about 75° C.

15. The method of claim 1, wherein the second resin is selected from the group consisting of polyester resins, styrene acrylic copolymers, polystyrene, hydrogenated styrene resins, styrene isobutylene copolymers, ABS resins, ASA resins, AS resins, AAS resins, ACS resins, AES resins, styrene propylene copolymers, styrene butadiene copolymers, (meth)acrylic resins, polyethylene, polypropylene, polyurethane resins, polyamide resins, silicone resins, and blends and copolymers thereof.

16. The method of claim 15, wherein the second resin has a glass transition temperature (T_{g}) from about 50° C. to about 120° C.

17. A method for coating particles comprising:
pre-conditioning a mixing device; and
mixing toner particles and a dispersion comprising shell particles in the pre-conditioned mixing device to cover at least a portion of an exterior surface of the toner particles with an essentially continuous layer of the shell particles, wherein the toner particles comprise a first resin and a coloring agent, and the shell particles comprise a second resin.

18. The method of claim 17, wherein the shell particles form an essentially continuous coating over at least 20% of the exterior surface of the toner particles.

19. The method of claim 17, wherein mixing toner particles and a dispersion defines a mixture, and wherein the shell particles are present in the mixture at a concentration of from about 0.1% by weight to about 20% by weight based on the weight of the toner particles.

20. A toner composition comprising:
a core toner particle comprising a first resin and a coloring agent; and
an essentially continuous coating surrounding the core toner particle, wherein the essentially continuous coating comprises a second resin, and wherein the first resin comprises polyester and the second resin comprises a styrene acrylic copolymer.

21. The toner composition of claim 20, wherein the core toner particle further comprises a releasing agent, a charge control agent, or a combination thereof.

22. The toner composition of claim 20, wherein the core toner particle has an average particle size by volume from about 2 micrometers to about 20 micrometers.

23. A toner composition comprising:
core toner particles comprising a first resin and a coloring agent; and
a shell in contact with an exterior surface of the core toner particles, wherein the shell forms an essentially continuous layer over at least 20% of the exterior surface of the core toner particles, wherein the shell particles comprises a second resin, and wherein the core toner particles have an average degree of roundness of 0.90 or less.

24. The toner composition of claim 23, wherein the core toner particles have an average degree of roundness of 0.80 or less.

25. The toner composition of claim 23, wherein the first resin has a glass transition temperature (T_{g}) equal to or lower than the glass transition temperature (T_{g}) of the second resin.

26. The toner composition of claim 23, wherein the core toner particles further comprise a releasing agent, a charge control agent, or a combination thereof.

27. The toner composition of claim 23, wherein the core toner particles have an average particle size by volume of from about 2 micrometers to about 20 micrometers.

28. A toner composition comprising:
core toner particles comprising a first resin and a coloring agent, wherein the core toner particles have a first average surface roughness number; and
a shell in contact with an exterior surface of the core toner particles, wherein the shell forms an essentially continuous layer over at least 20% of the exterior surface of the core toner particles, wherein the shell comprises a second resin, and wherein the core toner particles with the shell in contact with the exterior surface of the core toner particles have a second average surface roughness that is greater than the first average surface roughness number.

29. A toner composition comprising:
core toner particles comprising a first resin and a coloring agent, wherein the core toner particles have a first average degree of roundness; and
a shell in contact with an exterior surface of the core toner particles, wherein the shell forms an essentially continuous layer over at least 20% of the exterior surface of the core toner particles, wherein the shell comprises a second resin, and wherein the core toner particles with the shell in contact with the exterior surface of the core toner particles have a second average degree of roundness that is greater than the first average degree of roundness.
